(19) United States
(12) Patent Application Publication
(10) Pub. No.: US 2013/0311831 A1
(43) Pub. Date: Nov. 21, 2013

(54) VIRTUAL FAIL ADDRESS GENERATION SYSTEM, REDUNDANCY ANALYSIS SIMULATION SYSTEM, AND METHOD THEREOF

(71) Applicant: SAMSUNG ELECTRONICS CO., LTD., Suwon-si (KR)

(72) Inventors: Yoonna Oh, Seongnam-si (KR); Pil-Kyu Baek, Seoul (KR); Deok-Gu Yoon, Seoul (KR)

(73) Assignee: SAMSUNG ELECTRONICS CO., LTD., Suwon-si (KR)

(21) Appl. No.: 13/790,657

(22) Filed: Mar. 8, 2013

(30) Foreign Application Priority Data
May 15, 2012 (KR) 10-2012-0051438

(51) Int. Cl. G06F 11/07

(52) U.S. Cl. CPC G06F 11/0766
USPC 714/37

(57) ABSTRACT

A fault distribution generation system is provided. The fault distribution generation system comprises: a fail address mapping module which receives a fail bit map representing failures included in a semiconductor device as a plurality of pixels having a plurality of different failure levels and fail addresses for the failures included in the semiconductor device, and maps the fail addresses to each pixel of the fail bit map; a fault pattern analyzing module which receives information on each pixel to which the fail addresses are mapped from the fail address mapping module, analyzes the received information, and classifies the failures included in each pixel into predetermined fault patterns; and a fault distribution estimating module which estimates an occurrence probability distribution of the fault patterns according to the failure levels based on results of the classification of the fault pattern analyzing module.

### CROSS-REFERENCE TO RELATED APPLICATION

This U.S. non-provisional patent application claims priority under 35 U.S.C. 119 to Korean Patent Application No. 10-2012-0051438, filed on May 15, 2012 in the Korean Intellectual Property Office, the entirety of which is incorporated by reference herein.

### BACKGROUND

1. Technical Field

The present inventive concepts relate to a fault distribution generation system, a virtual fail address generation system, redundancy analysis simulation system, and method thereof.

2. Description of the Related Art

A process of manufacturing a semiconductor device includes design, fabrication, packaging and testing. The testing step of the manufacturing process is generally performed by a different method and apparatus than the other processing steps before or after packaging. However, as integration of semiconductor devices increases, the number of failures generated in the fabrication step may increase. Accordingly, if the failures included in the semiconductor device are determined through a testing step after packaging of the semiconductor device, the cost incurred by packaging defective wafers may increase. As a method of solving this problem, the testing step is performed in advance of packaging the semiconductor device when the device is in a wafer state, thereby reducing the cost incurred by packaging defective wafers.

The cells that are determined to be defective by performing the testing step when the semiconductor device is in the wafer state are replaced by redundancy cells according to a predetermined redundancy scheme and, thus, repaired. Accordingly, the redundancy scheme for the wafer becomes a factor that greatly affects the yield of the wafer. Thus, studies have been conducted on a method of designing the redundancy scheme that can maximize the yield of the wafer.

In one method for designing a redundancy scheme that can maximize the yield of the wafer, a redundancy analysis simulation may be provided. Generally, in order to perform the redundancy analysis simulation, a redundancy analysis algorithm, wafer configuration information, and actual fail addresses for the failures included in the wafer are necessary.

However, much time and cost is required to obtain the actual fail addresses for the failures included in the wafer from test equipment. Accordingly, there is a demand for a method for performing the redundancy analysis simulation at a lower cost.

### SUMMARY

The present inventive concepts provide a fault distribution generation system for estimating an occurrence probability distribution of fault patterns according to failure levels of a fail bit map (FBM).

The present inventive concepts also provide a virtual fail address generation system for generating virtual fail addresses for failures included in a wafer using the occurrence probability distribution of fault patterns generated by the fault distribution generation system.

The present inventive concepts also provide a redundancy analysis simulation system for performing a redundancy analysis simulation at a low cost by using the virtual fail addresses generated by the virtual fail address generation system.

The present inventive concepts also provide a wafer test system for performing testing on and repair of the failures included in the wafer based on a redundancy scheme that has been updated by the redundancy analysis simulation system.

The present inventive concepts also provide a virtual fail address generation method for generating virtual fail addresses for the failures included in the wafer using the occurrence probability distribution of fault patterns according to failure levels of the fail bit map.

The present inventive concepts also provide a redundancy analysis simulation method for performing a redundancy analysis simulation at a low cost by using the virtual fail address generation method.

The present inventive concepts are not limited thereto, and the other embodiments and features of the present inventive concepts will be described in or be apparent from the following description of the example embodiments.

According to an aspect of the present inventive concept, there is provided a fault distribution generation system comprising: a fail address mapping module which receives a fail bit map representing failures included in a semiconductor device as a plurality of pixels having a plurality of failure levels and fail addresses for the failures included in the semiconductor device, and maps the fail addresses to each pixel of the fail bit map; a fault pattern analyzing module which receives information on each pixel to which the fail addresses are mapped from the fail address mapping module, analyzes the received information, and classifies the failures included in each pixel into predetermined fault patterns; and a fault distribution estimating module which estimates an occurrence probability distribution of the fault patterns according to the failure levels based on results of the classification of the fault pattern analyzing module.

In some example embodiments, each pixel of the fail bit map has any one of first to i-th failure levels according to the number of the failures included in each pixel, wherein i is a natural number.

In some example embodiments, the fault patterns are classified into first to j-th fault patterns according to arrangement types of the failures, wherein j is a natural number.

In some example embodiments, the fault patterns include at least a single cell fault pattern, a fault pattern extending in a first direction in multiple adjacent cells, and a fault pattern extending in a second direction perpendicular to the first direction in multiple adjacent cells.

In some example embodiments, the occurrence probability distribution of the fault patterns includes a probability distribution on the number of occurrences of the fault patterns.

In another example embodiment, the fault distribution estimating module estimates the probability distribution by the following equation: Pr[i, j, k]=Occ[i, j, k]/ΣGi, where Pr[i, j, k] is a probability that the j-th fault pattern occurs k times in pixels having the i-th failure level, Occ[i, j, k] is the number of pixels having the i-th failure level, in which the j-th fault pattern occurs k times, and ΣGi is the number of all pixels having the i-th failure level in the fail bit map.

In some example embodiments, the semiconductor device includes a wafer on which a plurality of memory chips are arranged.

According to another aspect of the present inventive concepts, there is provided a virtual fail address generation system comprising: a storage unit which stores an occurrence probability distribution of the fault patterns according to the failure levels, which is estimated from a first fail bit map representing failures included in a first wafer as a plurality of pixels having a plurality of failure levels; and a virtual fail address generation module which receives a second fail bit map representing failures included in a second wafer as a plurality of pixels having a plurality of failure levels, and generates virtual fail addresses for the failures included in the second wafer using the occurrence probability distribution of the fault patterns of the first wafer stored in the storage unit.

In some example embodiments, the first wafer and the second wafer have the same characteristics. In another example embodiment, the characteristics include a yield of the wafer.

In some example embodiments, the first wafer is a wafer whose mass production has been completed, and the second wafer is a wafer whose mass production is in progress.

According to another aspect of the present inventive concepts, there is provided a redundancy analysis simulation system comprising: a virtual fail address generation system which receives a fail bit map representing failures included in a semiconductor device as a plurality of pixels having a plurality of failure levels, and generates virtual fail addresses for the failures included in the semiconductor device using an occurrence probability distribution of fault patterns according to the failure levels; and a redundancy analysis simulator which receives the virtual fail addresses from the virtual fail address generation system, and perform analysis and simulation on a redundancy scheme for the semiconductor device.

In some example embodiments, the semiconductor device includes a wafer on which a plurality of memory chips are arranged.

In some example embodiments, the redundancy analysis simulator updates the redundancy scheme based on results of the simulation.

According to another aspect of the present inventive concepts, there is provided a a wafer test system comprising: a fault distribution generation system estimating an occurrence probability distribution of fault patterns according to failure levels of a fail bit map; a virtual fail address generation system generating virtual fail addresses for failures in a first wafer using the occurrence probability distribution of fault patterns; a redundancy analysis simulation system performing a redundancy analysis simulation using the virtual fail addresses, generating a redundancy scheme and updating a redundancy scheme; and a testing system performing testing on the failures in the second wafer based on the updated redundancy scheme.

In some example embodiments, the the occurrence probability distribution of the fault patterns includes a probability distribution on a number of occurrences of the fault patterns in a second wafer.

In some example embodiments, the fault distribution generation system estimates the probability distribution by the following equation: Pr[i, j, k]=Occ[i, j, k]/ΣGi, where Pr[i, j, k] is a probability that a j-th fault pattern occurs k times in pixels having an i-th failure level, Occ[i, j, k] is the number of pixels having the i-th failure level, in which the j-th fault pattern occurs k times, and ΣGi is the number of all pixels having the i-th failure level in the fail bit map

In some example embodiments, the redundancy analysis simulator updates the redundancy scheme based on results of the simulation.

In some example embodiments, the occurrence probability distribution of the fault patterns is estimated using actual fail addresses for failures included in a second wafer.

### BRIEF DESCRIPTION OF THE DRAWINGS

The foregoing and other features and advantages of the inventive concepts will be apparent from the more particular description of preferred embodiments of the inventive concepts, as illustrated in the accompanying drawings in which like reference characters refer to the same parts throughout the different views. The drawings are not necessarily to scale, emphasis instead being placed upon illustrating the principles of the inventive concepts.

FIG. 1 is a block diagram of a fault distribution generation system in accordance with an example embodiment of the present inventive concepts.

FIGS. 2 to 7 are diagrams illustrating an operation of a fault distribution generation system in accordance with an example embodiment of the present inventive concepts.

FIG. 8 is a block diagram of a virtual fail address generation system in accordance with an example embodiment of the present inventive concepts.

FIG. 9 is a block diagram of a redundancy analysis simulation system in accordance with an example embodiment of the present inventive concepts.

FIG. 10 is a block diagram of a wafer test system in accordance with an example embodiment of the present inventive concepts.

FIG. 11 illustrates a semiconductor device in accordance with an example embodiment of the present inventive concepts.

### DETAILED DESCRIPTION OF THE EMBODIMENTS

Various example embodiments will be described more fully hereinafter with reference to the accompanying drawings, in which some example embodiments are shown. The present inventive concepts may, however, be embodied in many different forms and should not be construed as being limited to the example embodiments set forth herein.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on”, “directly connected to” or “directly coupled to” another element or layer, there are no intervening elements or layers present. Like numbers refer to like elements throughout. As used herein, the term “and/or” includes any and all combinations of one or more of the associated listed items.

The terminology used herein is for the purpose of describing particular example embodiments only and is not intended to be limiting of the present inventive concepts. As used herein, the singular forms “a”, “an” and “the” and similar referents in the context of describing the invention (especially in the context of the following claims) are intended to include the plural forms as well, unless the context clearly indicates otherwise. It will be further understood that the terms “comprise” and/or “comprising,” “have” and/or “having,” “include” and/or “including,” and “contain” and/or “containing,” when used in this specification, specify the presence of states features, integers, steps, operations, elements and/or components, but do not preclude the presence of addition of one or more other features, integers, steps, operations, elements, components, and/or groups thereof.

It will be understood that, although the terms first, second, etc. may be used herein to describe various elements, components, regions, layers and/or sections, these elements, components, regions, layers and/or sections should not be limited by these terms. These terms are only used to distinguish one element, components, region, layer and/or section from another element, component, region, layer and/or section. Thus, for example, a first element, component, region, layer and/or section discussed below could be termed a second element, component, region, layer and/or section without departing from the teachings of the present inventive concepts.

Exemplary embodiments are described herein with reference to cross-sectional illustrations that are schematic illustrations of idealized exemplary embodiments (and intermediate structures). As such, variations from the shapes of the illustrations as a result, for example, of manufacturing techniques and/or tolerances, are to be expected. Thus, exemplary embodiments should not be construed as limited to the particular shapes of regions illustrated herein but are to include deviations in shapes that result, for example, from manufacturing. Thus, the regions illustrated in the figures are schematic in nature and their shapes are not intended to illustrate the actual shape of a region of a device and are not intended to limit the scope of the present inventive concepts.

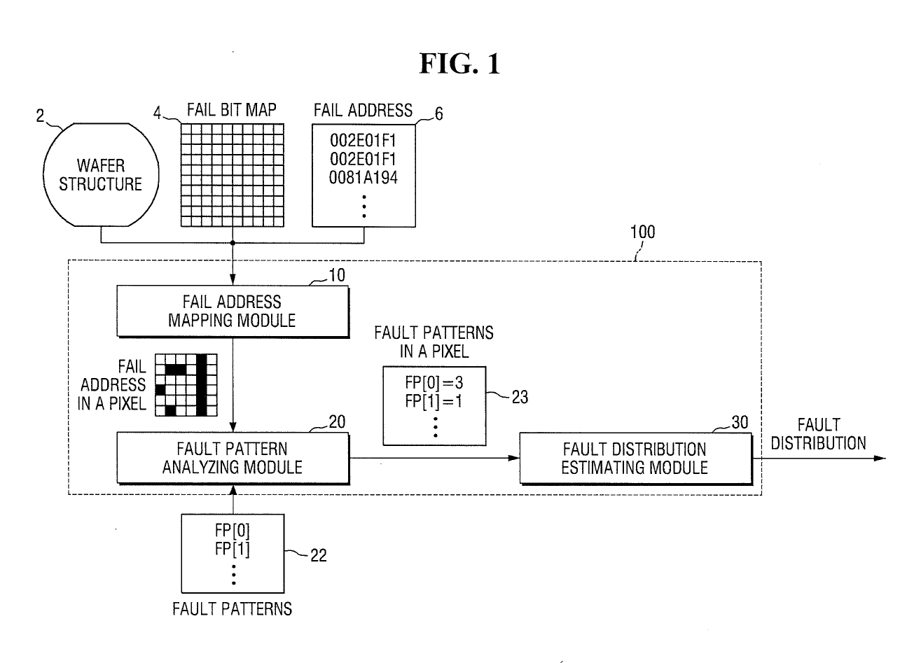

Hereinafter, a fault distribution generation system in accordance with an example embodiment of the present inventive concepts will be described with reference to FIGS. 1 to 7.

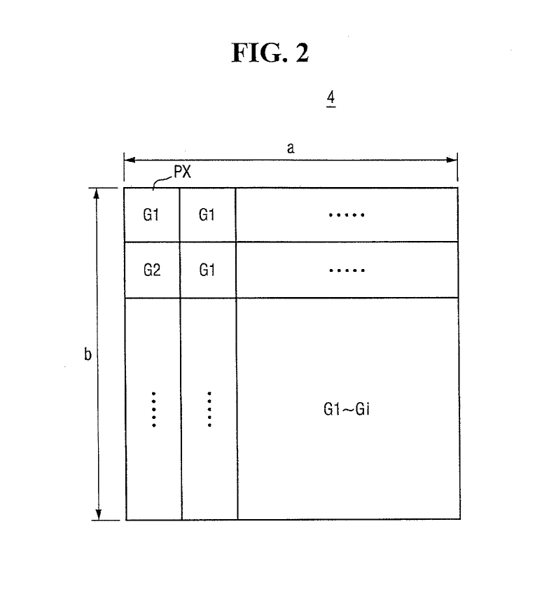

FIG. 1 is a block diagram of a fault distribution generation system in accordance with an example embodiment of the present inventive concepts. FIGS. 2 to 7 are diagrams illustrating an operation of the fault distribution generation system in accordance with an example embodiment of the present inventive concepts.

The term “unit” or “module”, as used herein, means, but is not limited to, a software or hardware component, for example a field programmable gate array (FPGA) or an application specific integrated circuit (ASIC), which performs certain tasks. A unit or module may advantageously be configured to reside in the addressable storage medium and configured to execute on one or more processors. Thus, a unit or module may include, for example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and units or modules may be combined into fewer components and units or modules or further separated into additional components and units or modules.

Further, in the following description, a wafer on which a plurality of memory chips are arranged is described as an example of a semiconductor device in accordance with an example embodiment of the present inventive concepts, but the present inventive concepts are not limited thereto.

First, referring to FIG. 1, a fault distribution generation system 100 may include a fail address mapping module 10, a fault pattern analyzing module 20, and a fault distribution estimating module 30.

The fail address mapping module 10 may receive wafer structure information 2. In addition, the fail address mapping module 10 may receive a fail bit map (FBM) 4 representing failures included in the wafer as a plurality of pixels having a plurality of different failure levels. In addition, the fail address mapping module 10 may receive actual fail addresses 6 for the failures included in the wafer. The fail address mapping module 10 may map the fail addresses 6 to each pixel of the FBM 4.

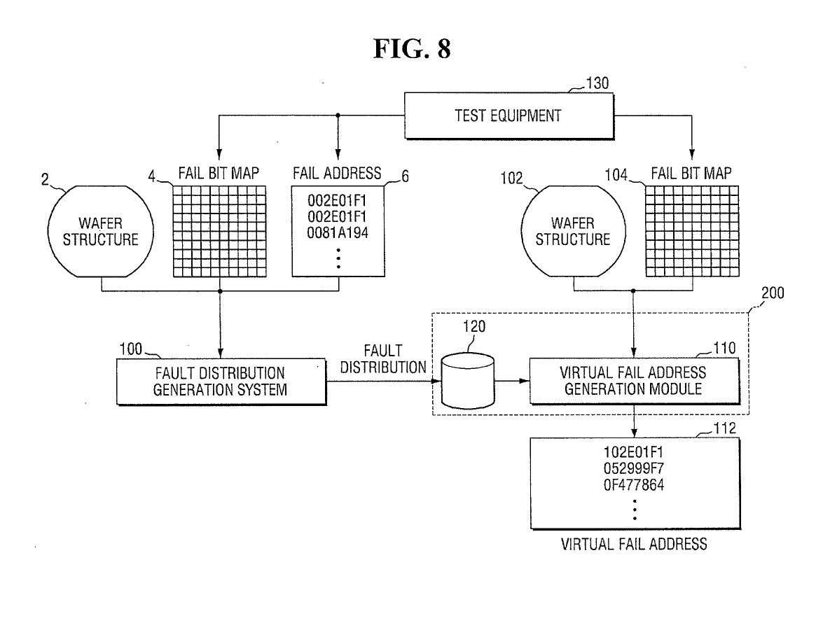

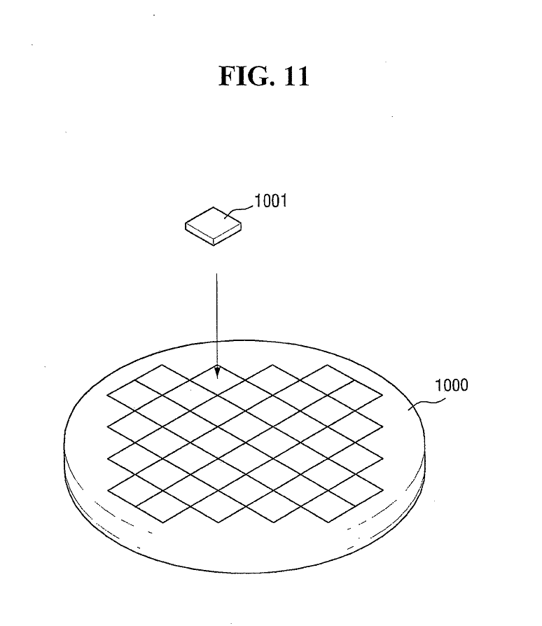

Specifically, referring to FIG. 2, a plurality of pixels PX may be included in the FBM 4 that is provided to the fail address mapping module 10 through test equipment (for example, test equipment 130 of FIG. 8) or the like. The number of the pixels PX may be, for example, a×b as shown in FIG. 2. In some example embodiments, a predetermined number of the pixels may correspond to one memory chip (for example, memory chip 1001 of FIG. 11) arranged on a wafer (for example, wafer 1000 of FIG. 11). For example, assuming that 10×10 memory chips are arranged on the wafer and one chip is represented by 2×2 pixels PX, the FBM 4 for the failures included in the entire wafer may be represented by 20×20 pixels PX.

Each of the pixels PX of the FBM 4 may have any one of a plurality of different failure levels G1 to Gi according to the number of failures included in corresponding region of the wafer. For example, if one pixel PX corresponds to one memory chip (for example, memory chip 1001 of FIG. 11) arranged on the wafer (for example, wafer 1000 of FIG. 11), the one pixel PX may have any one of the plurality of different failure levels G1 to Gi according to the number of failures included in one memory chip (for example, memory chip 1001 of FIG. 11). In this example embodiment, as the number of failures included in the corresponding region of the wafer increases, the failure level G1˜Gi of each pixel PX may increase. That is, the pixel PX having the second failure level G2 may include more failures than the pixel PX having the first failure level G1.

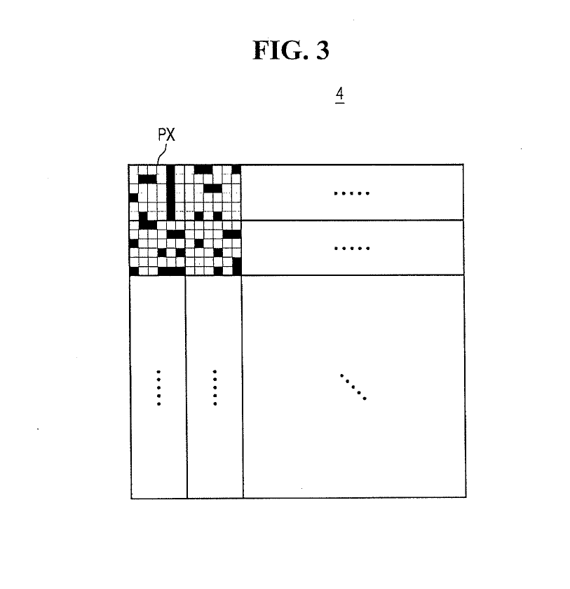

The fail address mapping module 10 may map the actual fail addresses 6 for the failures included in the wafer to each pixel PX of the FBM 4. Consequently, as shown in FIG. 3, the actual fail addresses 6 for the failures included in the wafer are mapped to each pixel PX of the FBM 4.

Referring to FIG. 1, the fault pattern analyzing module 20 receives information on each pixel to which the fail addresses are mapped from the fail address mapping module 10 and receives predetermined fault patterns 22. The fault pattern analyzing module 20 analyzes the received information, and classifies the failures included in each pixel into predetermined fault patterns 22.

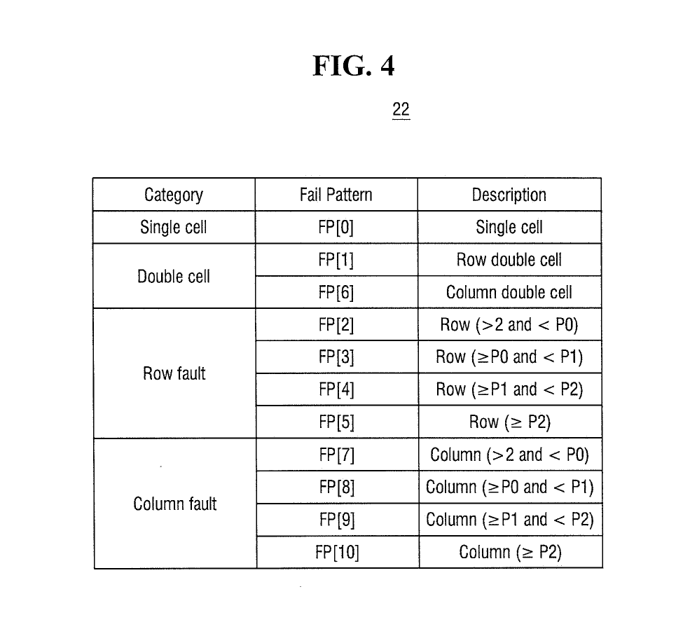

In this embodiment, the predetermined fault patterns 22 may include, for example, as shown in FIG. 4, first to eleventh fault patterns FP[0]˜FP[10] that are distinguished from each other according to the arrangement type of failures.

Referring to FIG. 4, specifically, the first fault pattern FP[0] may represent a failure solely generated in a single cell of the pixel PX.

Further, the second fault pattern FP[1] may represent a failure generated in two cells of the pixel PX adjacent to each other in a row direction, and the seventh fault pattern FP[6] may represent a failure generated in two cells adjacent to each other in a column direction.

Further, the third fault pattern FP[2] may represent a failure generated in adjacent cells of the pixel PX in which the number of cells is greater than 2 and less than P0 and in which the cells are adjacent to each other in the row direction. The fourth fault pattern FP[3] may represent a failure generated in adjacent cells of the pixel PX in which the number of cells is equal to or greater than P0 and less than P1 and in which the cells are adjacent to each other in the row direction. The fifth fault pattern FP[4] may represent a failure generated in adjacent cells of the pixel PX in which the number of cells is equal to or greater than P1 and less than P2 and in which the cells are adjacent to each other in the row direction. The sixth fault pattern FP[5] may represent a failure generated in adjacent cells of the pixel PX in which the number of cells is equal to or greater than P2 and in which the cells are adjacent to each other in the row direction.

Further, the eighth fault pattern FP[7] may represent a failure generated in adjacent cells of the pixel PX in which the number of cells is greater than 2 and less than P0 and in which the cells are adjacent to each other in the column direction. The ninth fault pattern FP[8] may represent a failure generated in adjacent cells of the pixel PX in which the number of cells is equal to or greater than P0 and less than P1 and in which the cells are adjacent to each other in the column direction. The tenth fault pattern FP[9] may represent a failure generated in adjacent cells of the pixel PX in which the number of cells is equal to or greater than P1 and less than P2 and in which the cells are adjacent to each other in the column direction. The eleventh fault pattern FP[10] may represent a failure generated in adjacent cells of the pixel PX in which the number of cells is equal to or greater than P2 and in which the cells are adjacent to each other in the column direction.

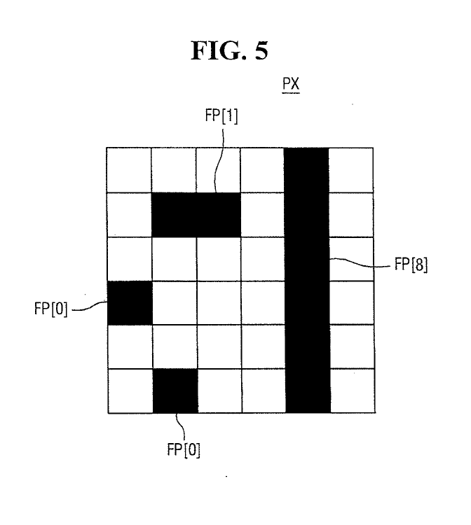

The fault pattern analyzing module 20 analyzes each pixel PX of the FBM 4 to which the fail addresses 6 are mapped, and classifies the failures included in each pixel PX into the first to eleventh fault patterns FP[0]˜FP[10]. A description thereof will be made in detail using, for example, the pixel PX shown in FIG. 5. In this example embodiment, the values of P0 and P1 shown in FIG. 4 are assumed to be 5 and 7 respectively.

Referring to FIG. 5, since there are two failures, each being solely generated in a single cell, in the pixel PX, the pixel PX includes two first fault patterns FP[0]. Further, since there is one failure generated in two cells adjacent to each other in the row direction in the pixel PX, the pixel PX includes one second fault pattern FP[1]. Finally, since there is one failure generated in six cells adjacent to each other in the column direction in the pixel PX, the pixel PX includes one ninth fault pattern FP[8].

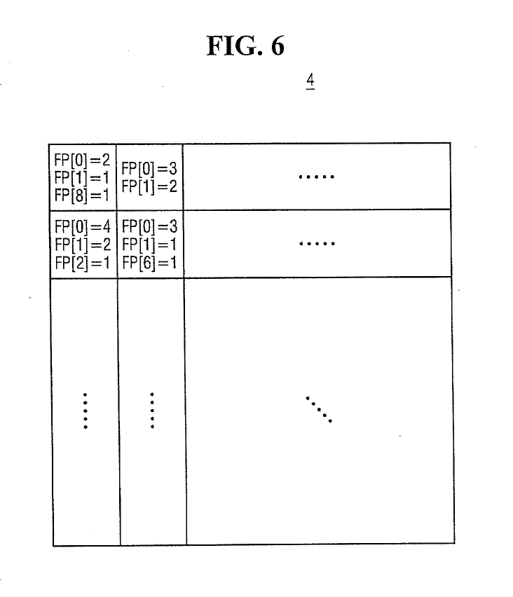

If the failures included in each pixel PX of the FBM 4 of FIG. 3 are classified into the first to eleventh fault patterns FP[0]˜FP[10] in this way, the results as shown in FIG. 6 may be obtained.

Referring to FIG. 1, the fault distribution estimating module 30 estimates the fault distribution of the fault patterns (FP[0]˜FP[10]) 22 according to the failure levels G1 to Gi based on the classification results 23 (see, e.g., FIG. 6) of the fault pattern analyzing module 20. Specifically, the fault distribution estimating module 30 may estimate the probability distribution on the number of occurrences of the fault patterns FP[0]˜FP[10] according to the failure levels G1 to Gi based on the classification results 23 (see, for example, FIG. 6) of the fault pattern analyzing module 20.

More specifically, the fault distribution estimating module 30 according to the example embodiment of the present inventive concepts may estimate the probability distribution on the number of occurrences of the fault patterns FP[0]˜FP[10] according to the failure levels G1 to Gi by the following equation:

Pr[i, j, k]=Occ[i, j, k]/ΣGi,

where Pr[i, j, k] is the probability that the j-th fault pattern FP[j-1] occurs k times in pixels having the i-th failure level Gi, Occ[i, j, k] is the number of pixels having the i-th failure level Gi, in which the j-th fault pattern FP[j-1] occurs k times, and ΣGi is the number of all pixels having the i-th failure level Gi in the fail bit map. In some embodiments, i, j and k are natural numbers.

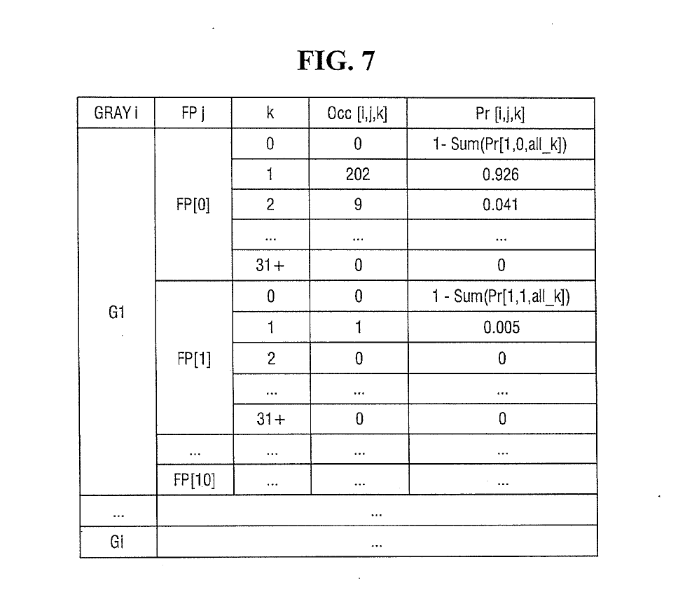

An example of the probability distribution estimated by the above equation is illustrated in FIG. 7. Referring to FIG. 7, since the number of the pixels PX in which the first fault pattern FP[0] occurs one time among the pixels having the first failure level G1 in the FBM 4 is 202 (Occ[1, 1, 1]), it is divided by the number (ΣG1) of all pixels having the first failure level G1 in the FBM 4, thereby estimating the probability Pr[1,1,1] to be 0.926 which is the probability that the first fault pattern FP[0] occurs one time in the pixels PX having the first failure level G1 in the FBM 4.

Further, since the number of the pixels PX in which the first fault pattern FP[0] occurs two times among the pixels having the first failure level G1 in the FBM 4 is 9 (Occ[1, 1, 2]), it is divided by the number (ΣG1) of all pixels having the first failure level G1 in the FBM 4, thereby estimating the probability Pr[1,1,2] to be 0.041 which is the probability that the first fault pattern FP[0] occurs two times in the pixels PX having the first failure level G1 in the FBM 4.

Similarly, since the number of the pixels PX in which the second fault pattern FP[1] occurs one time among the pixels having the first failure level G1 in the FBM 4 is 1 (Occ[1, 2, 1]), it is divided by the number (ΣG1) of all pixels having the first failure level G1 in the FBM 4, thereby estimating the probability Pr[1,2,1] to be 0.005 which is the probability that the second fault pattern FP[1] occurs one time in the pixels PX having the first failure level G1 in the FBM 4.

Further, since the number of the pixels PX in which the second fault pattern FP[1] occurs two times among the pixels having the first failure level G1 in the FBM 4 is 0 (Occ[1, 2, 2]), it is divided by the number (ΣG1) of all pixels having the first failure level G1 in the FBM 4, thereby estimating the probability Pr[1,2,1] to be 0 which is the probability that the second fault pattern FP[1] occurs two times in the pixels PX having the first failure level G1 in the FBM 4.

When the above process is repeated for all the failure levels G1˜Gi and all the fault patterns FP[0]˜FP[10], it is possible to estimate the probability distribution on the number of occurrences of the fault patterns FP[0]˜FP[10] according to the failure levels G1 to Gi as shown in FIG. 7. The estimated probability distribution on the number of occurrences of the fault patterns FP[0]˜FP[10] according to the failure levels G1 to Gi may be stored in a separate storage unit (not shown) if necessary.

Hereinafter, a virtual fail address generation system and method thereof in accordance with an example embodiment of the present inventive concepts will be described with reference to FIG. 8.

FIG. 8 is a block diagram of a virtual fail address generation system in accordance with an example embodiment of the present inventive concepts.

Referring to FIG. 8, a virtual fail address generation system 200 may include a storage unit 120 and a virtual fail address generation module 110.

The virtual fail address generation system 200 may receive the fault distribution of the fault patterns (probability distribution) from the fault distribution generation system 100 (for example, the probability distribution as illustrated in connection with FIG. 7). The storage unit 120 may store the fault distribution (probability distribution) (for example, as illustrated in FIG. 7) of the fault patterns FP[0]˜FP[10] according to the failure levels G1˜Gi, which is estimated from a first FBM 4 representing failures included in a first wafer as a plurality of pixels having different failure levels G1˜Gi. Since the process of estimating the probability distribution has been fully described in connection with the fault distribution generation system 100, a repeated description will be omitted.

The virtual fail address generation module 110 may receive a second fail bit map FBM 104 representing failures included in a second wafer as a plurality of pixels having different failure levels G1˜Gi and structure information 102 regarding the second wafer, and generate virtual fail addresses 112 for the failures included in the second wafer using the probability distribution generated by the fault distribution generation system 100 (see, for example, FIG. 7) and stored in the storage unit 120.

In this example embodiment, the first wafer and the second wafer may be wafers having the same characteristics. Specifically, the first wafer and the second wafer may be, for example, wafers having the same yield (for example, 80). More specifically, the first wafer may be a wafer which has a yield of 80, but whose mass production has been completed, and the second wafer may be a wafer which has a yield of 80, but whose mass production is in progress.

Creating the virtual fail addresses 112 by the virtual fail address generation module 110 may be performed in the reverse order of the above-described operation of the fault distribution generation system 100.

Specifically, first, upon receipt of the second FBM 104 for the second wafer from test equipment 130 or the like, the virtual fail address generation module 110 allocates the fault patterns FP[0]˜FP[10] to each pixel of the second FBM 104 using the probability distribution stored in the storage unit 120. In this case, the type and number of the fault patterns FP[0]˜FP[10] to be allocated to each pixel may be changed according to the failure levels G1˜Gi of each pixel.

For example, assuming that the probability distribution generated by fault distribution generation system 100 shown in FIG. 7 is stored in the storage unit 120, referring to FIG. 7, in the pixel PX having the first failure level G1, one first fault pattern FP[0] may exist at a probability of 92.6, and two first fault patterns FP[0] may exist at a probability of 4.1. Accordingly, the virtual fail address generation module 110 randomly allocates one first fault pattern FP[0] at a probability of 92.6 and randomly allocates two first fault patterns FP[0] at a probability of 4.1 to the pixel PX having the first failure level G1 of the second FBM 104. Further, in the pixel PX having the first failure level G1, one second fault pattern FP[1] may exist at a probability of 0.5. Accordingly, the virtual fail address generation module 110 randomly allocates one second fault pattern FP[1] at a probability of 0.5 to the pixel PX having the first failure level G1 of the second FBM 104. When the above process is performed on all pixels PX of the second FBM 104, virtual failures included in each pixel PX of the second FBM 104 may be represented as shown in FIG. 3.

Then, when the virtual failures are made to correspond to the received structure information 102 regarding the second wafer, it is possible to create the virtual fail addresses 112 for the failures included in the second wafer.

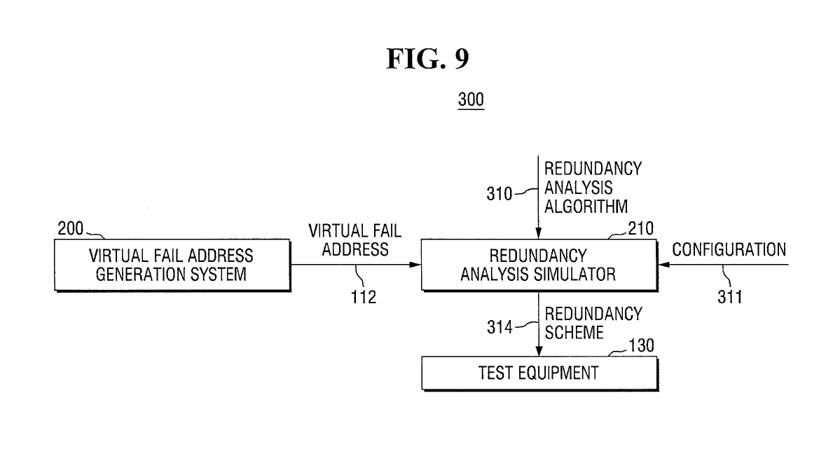

Next, a redundancy analysis simulation system and method thereof in accordance with an example embodiment of the present inventive concepts will be described with reference to FIG. 9.

FIG. 9 is a block diagram of a redundancy analysis simulation system in accordance with an example embodiment of the present inventive concepts.

Referring to FIG. 9, a redundancy analysis simulation system 300 may include the virtual fail address generation system 200, for example, as illustrated in FIG. 8, and a redundancy analysis simulator 210.

The virtual fail address generation system 200 may generate virtual fail addresses for the failures included in the wafer through the method as described above in connection with FIG. 8.

The redundancy analysis simulator 210 may receive a redundancy analysis algorithm 310, wafer configuration information 311, and the virtual fail addresses 112 for the failures included in the wafer from the virtual fail address generation system 200, and perform analysis and simulation on a redundancy scheme for the wafer using them. Further, the redundancy analysis simulator 210 may update the redundancy scheme for the wafer based on the results of the simulation and provide the updated redundancy scheme 314 to the test equipment 130 or the like.

As described above, the redundancy analysis simulation system 300 according to this example embodiment generates the virtual fail addresses 112 and performs the redundancy analysis simulation based on the virtual fail addresses 112, for example, for at least the following reason.

Referring to FIGS. 8 and 9, in order to perform the redundancy analysis simulation to verify the redundancy scheme affecting the yield of the wafer, the actual fail addresses 6 of the failures included in the wafer are necessary. However, it is costly to obtain the actual fail addresses 6 from the test equipment 130.

On the other hand, the FBM 4 and FBM 104 formed based on the failures included in the wafer can be obtained at a relatively low cost compared to the actual fail addresses 6. Accordingly, if the virtual fail addresses 112 of the failures included in the wafer, as illustrated in FIG. 8, are generated based on the FBM 4 and FBM 104 and the redundancy analysis simulation is performed based on the virtual fail addresses as in the example embodiment of the present inventive concepts as illustrated in FIG. 9, the redundancy analysis simulation can be efficiently performed at a low cost.

Thus, in this example embodiment of the present inventive concepts, based on the first FBM 4 for the first wafer (for example, a wafer which has a yield of 80 and whose mass production has been completed) that can be obtained from the test equipment 130 and the actual fail addresses 6 for the first wafer, the probability distribution on the number of occurrences of the fault patterns FP[0]˜FP[10] according to the failure levels G1 to Gi of the FBM 4 is estimated and stored in advance in the storage unit 120.

Then, when obtaining the second FBM 104 for the second wafer (for example, a wafer which has a yield of 80 in the same manner as the first wafer and whose mass production is in progress) from the test equipment 130, the virtual fail addresses 112 for the failures included in the second wafer are generated using the probability distribution stored in the storage unit 120. The fail addresses 112 generated in this way are virtual fail addresses rather than addresses of actual failures included in the second wafer. However, since the virtual fail addresses 112 are generated based on the probability distribution for the fault patterns that may be included in the wafer having a yield of 80, they may be very similar to those of the failures that may be actually included in the second wafer in terms of the fault patterns. Accordingly, even if the redundancy analysis simulation is performed based on the virtual fail addresses, the redundancy scheme being applied to the wafer having a yield of 80 can be reliably verified. That is, in the redundancy analysis simulation system and method thereof according to the example embodiment of the present inventive concepts, there is an advantage that the redundancy analysis simulation may be reliably performed at a low cost.

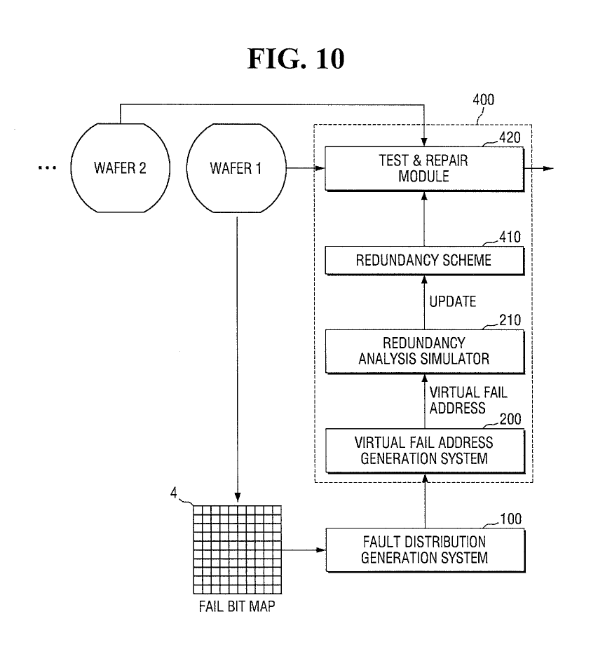

FIG. 10 is a block diagram of a wafer test system in accordance with an example embodiment of the present inventive concepts.

Referring to FIG. 10, a wafer test system 400 may include the virtual fail address generation system 200, the redundancy analysis simulator 210, a redundancy scheme 410 and a test-repair module 420.

The fault distribution generation system 100 may receive a fail bit map, for example fail bit map 4 as illustrated in FIG. 1 representing failures included in a first wafer (wafer 1) (for example, a wafer which has a yield of 80 and whose mass production is in progress) as a plurality of pixels having a plurality of different failure levels and generate an occurrence probability distribution of the fault patterns for the first wafer (wafer 1). The virtual fail address generation system 200 may receive the probability distribution for the fault patterns for the first wafer (wafer 1), and generate the virtual fail addresses for the failures included in the first wafer (wafer 1) using the occurrence probability distribution of the fault patterns according to the failure levels. Since the detailed operation of the virtual fail address generation system 200 has been fully described above, a repeated description will be omitted.

The redundancy analysis simulator 210 may receive the virtual fail addresses from the virtual fail address generation system 200, perform analysis and simulation on a redundancy scheme 410 of the first wafer (wafer 1), and update the redundancy scheme 410 of the first wafer (wafer 1) based on the results of the simulation. Since the detailed operation of the redundancy analysis simulator 210 has been fully described above, a repeated description will be omitted.

The test-repair module 420 may receive a second wafer (wafer 2) having the same characteristics as those of the first wafer (wafer 1) (e.g., wafer which has a yield of 80 and whose mass production is in progress), and perform the test and repair for the failures included in the second wafer (wafer 2) based on the updated redundancy scheme 410. In some embodiments of the present inventive concepts, the test-repair module 420 may include wafer test equipment, but the present inventive concepts are not limited thereto.

FIG. 11 illustrates a semiconductor device in accordance with an example embodiment of the present inventive concepts.

Referring to FIG. 11, the semiconductor device may include, for example, a wafer 1000 on which a plurality of memory chips 1001 are arranged. In this embodiment, the wafer 1000 may be a wafer on which at least one of the testing and repairing is performed based on the redundancy scheme that has been updated by the redundancy analysis simulation system and method thereof as described above in connection with FIG. 10. However, the present inventive concepts are not limited to the illustrated example, and the type of the semiconductor device in accordance with embodiments of the present inventive concepts may be modified in a different way. For example, in some other embodiments of the present inventive concepts, the semiconductor device may be a semiconductor package (not shown) in which multiple wafers 1000 have been stacked. In this embodoment, each of the wafers 1000 may be a wafer on which at least one of the test and repair is performed based on the redundancy scheme that has been updated by the above-described redundancy analysis simulation system and method thereof.

The foregoing is illustrative of example embodiments in accordance with principles of inventive concepts and is not to be construed as limiting thereof Although example embodiments in accordance with principles of inventive concepts have been described, those skilled in the art will readily appreciate that many modifications are possible in example embodiments without materially departing from the novel teachings and advantages of example embodiments. Accordingly, all such modifications are intended to be included within the scope of example embodiments in accordance with principles of inventive concepts as defined in the claims. In the claims, means-plus-function clauses are intended to cover the structures described herein as performing the recited function and not only structural equivalents but also equivalent structures. Therefore, it is to be understood that the foregoing is illustrative of various example embodiments in accordance with principles of inventive concepts and is not to be construed as limited to the specific example embodiments in accordance with principles of inventive concepts disclosed, and that modifications to the disclosed example embodiments in accordance with principles of inventive concepts, as well as other example embodiments in accordance with principles of inventive concepts, are intended to be included within the scope of the appended claims.

What is claimed is:

1. A fault distribution generation system comprising:
a fail address mapping module which receives a fail bit map representing failures included in a semiconductor device as a plurality of pixels having a plurality of failure levels and fail addresses for the failures included in the semiconductor device, and maps the fail addresses to each pixel of the fail bit map;
a fault pattern analyzing module which receives information on each pixel to which the fail addresses are mapped from the fail address mapping module, analyzes the received information, and classifies the failures included in each pixel into predetermined fault patterns; and
a fault distribution estimating module which estimates an occurrence probability distribution of the fault patterns according to the failure levels based on results of the classification of the fault pattern analyzing module.

2. The fault distribution generation system of claim 1, wherein each pixel of the fail bit map has any one of first to i-th failure levels according to the number of the failures included in each pixel, wherein i is a natural number.

3. The fault distribution generation system of claim 1, wherein the fault patterns are classified into first to j-th fault patterns according to arrangement types of the failures, wherein j is a natural number.

4. The fault distribution generation system of claim 3, wherein the fault patterns include at least a single cell fault pattern, a fault pattern extending in a first direction in multiple adjacent cells, and a fault pattern extending in a second direction perpendicular to the first direction in multiple adjacent cells.

5. The fault distribution generation system of claim 1, wherein the occurrence probability distribution of the fault patterns includes a probability distribution on the number of occurrences of the fault patterns.

6. The fault distribution generation system of claim 5, wherein the fault distribution estimating module estimates the probability distribution by the following equation:
Pr[i, j, k]=Occ[i, j, k]/ΣGi,
where Pr[i, j, k] is a probability that a j-th fault pattern occurs k times in pixels having an i-th failure level, Occ[i, j, k] is the number of pixels having the i-th failure level, in which the j-th fault pattern occurs k times, and ΣGi is the number of all pixels having the i-th failure level in the fail bit map.

7. The fault distribution generation system of claim 1, wherein the semiconductor device includes a wafer on which a plurality of memory chips are arranged.

8. A virtual fail address generation system comprising:
a storage unit which stores an occurrence probability distribution of fault patterns according to the failure levels, which is estimated from a first fail bit map representing failures included in a first wafer as a plurality of pixels having a plurality of failure levels; and
a virtual fail address generation module which receives a second fail bit map representing failures included in a second wafer as a plurality of pixels having a plurality of failure levels, and generates virtual fail addresses for the failures included in the second wafer using the occurrence probability distribution of the fault patterns of the first wafer stored in the storage unit.

9. The virtual fail address generation system of claim 8, wherein the first wafer and the second wafer have the same characteristics.

10. The virtual fail address generation system of claim 9, wherein the characteristics include a yield of the wafer.

11. The virtual fail address generation system of claim 8, wherein the first wafer is a wafer whose mass production has been completed, and the second wafer is a wafer whose mass production is in progress.

12. The virtual fail address generation system of claim 8, wherein the occurrence probability distribution of the fault patterns stored in the storage unit is estimated using actual fail addresses for the failures included in the first wafer.

13. A redundancy analysis simulation system comprising:
a virtual fail address generation system which receives a fail bit map representing failures included in a semiconductor device as a plurality of pixels having a plurality of failure levels, and generates virtual fail addresses for the failures included in the semiconductor device using an occurrence probability distribution of fault patterns according to the failure levels; and
a redundancy analysis simulator which receives the virtual fail addresses from the virtual fail address generation system, and perform analysis and simulation on a redundancy scheme for the semiconductor device.

14. The redundancy analysis simulation system of claim 13, wherein the semiconductor device includes a wafer on which a plurality of memory chips are arranged.

15. The redundancy analysis simulation system of claim 14, wherein the redundancy analysis simulator updates the redundancy scheme based on results of the simulation.

16. A wafer test system comprising:
a fault distribution generation system estimating an occurrence probability distribution of fault patterns according to failure levels of a fail bit map;
a virtual fail address generation system generating virtual fail addresses for failures in a first wafer using the occurrence probability distribution of fault patterns;
a redundancy analysis simulation system performing a redundancy analysis simulation using the virtual fail addresses, generating a redundancy scheme and updating a redundancy scheme; and
a testing system performing testing on the failures in the second wafer based on the updated redundancy scheme.

17. The wafer test system of claim 16, wherein the occurrence probability distribution of the fault patterns includes a probability distribution on a number of occurrences of the fault patterns in a second wafer.

18. The wafer test system of claim 17, wherein the fault distribution generation system estimates the probability distribution by the following equation:
Pr[i, j, k]=Occ[i, j, k]/ΣGi,
where Pr[i, j, k] is a probability that a j-th fault pattern occurs k times in pixels having an i-th failure level, Occ[i, j, k] is the number of pixels having the i-th failure level, in which the j-th fault pattern occurs k times, and ΣGi is the number of all pixels having the i-th failure level in the fail bit map.

19. The wafer test system of claim 16, wherein the redundancy analysis simulator updates the redundancy scheme based on results of the simulation.

20. The wafer test system of claim 16, wherein the occurrence probability distribution of the fault patterns is estimated using actual fail addresses for failures included in a second wafer.
